(19) United States
(12) Patent Application Publication
(10) Pub. No.: US 2023/0297640 A1
(43) Pub. Date: Sep. 21, 2023

(54) STATE OUTPUT SYSTEM, STATE OUTPUT METHOD, AND STATE OUTPUT PROGRAM

(71) Applicant: NEC Corporation, Minato-ku, Tokyo (JP)

(72) Inventors: Motoi Suzuki, Tokyo (JP); Hiroaki Inoue, Tokyo (JP); Takuya Araki, Tokyo (JP); Fumiyo Takano, Tokyo (JP); Yuki Kobayashi, Tokyo (JP); Hiroshi Chishima, Tokyo (JP); Akihiro Yatabe, Tokyo (JP); Takahiro Nishimura, Tokyo (JP)

(73) Assignee: NEC Corporation, Minato-ku, Tokyo (JP)

(21) Appl. No.: 18/016,915

(22) PCT Filed: Jul. 30, 2020
(86) PCT No.: PCT/JP2020/029355

§ 371 Date: Jan. 19, 2023

(51) Int. Cl. G06F 17/11

(52) U.S. Cl. CPC G06F 17/11

(57) ABSTRACT

A state output system includes a solving unit which executes a solving process for solving a combinatorial optimization problem by a simulated annealing method, an acquiring unit which acquires data indicating states of the solving process in execution from the solving unit, and an outputting unit which outputs the acquired data during the execution of the solving process.

### TECHNICAL FIELD

The present invention relates to a state output system, a state output method, and a state output program.

### BACKGROUND ART

The practical application of quantum annealing machines has triggered renewed interest in a study on combinatorial optimization problems. Combinatorial optimization problems are problems of finding optimal combinations. Examples of combinatorial optimization problems that represent real-world problems include the traveling salesman problem, the knapsack problem, the shift optimization problem, and the delivery planning problem.

The shift optimization problem, for example, is the problem of constructing the shifts of six employees over a 14-day period in such a way that the various constraints imposed on them are satisfied. The imposed constraints are: “No one employee is allowed to work four consecutive days or to take four consecutive holidays,” “The number of employees working in a day must be between three and four,” “Each employee must reflect his or her vacation wishes,” and “ensure that the number of days worked by all employees is not biased,” etc.

FIG. 9 is an explanatory diagram showing an example of a solution to the shift optimization problem. FIG. 9 shows the shifts of six employees A-F over a 14-day period obtained by solving the shift optimization problem. Specifically, the “◯” and “X” shown in FIG. 9 represent “attendance” and “vacation,” respectively.

The above-described combinatorial optimization problem is described, for example, in Ising model form. The Ising model is a statistical mechanical model that represents the behavior of a magnetic material by its individual spins. In the Ising model, the orientation of each spin is represented by “1” or “−1”. The Ising model can formulate many combinatorial optimization problems.

When the combinatorial optimization problem is described in Ising model form, the equation representing the energy in the combinatorial optimization problem is first generated. Then, the equation representing the energy in the combinatorial optimization problem is converted to the energy function in the Ising model. The method of conversion to the energy function in the Ising model is well known. The energy function in the Ising model is represented as in the following Equation (1).

[Math. 1]

H_{Ising}=ΣᵢⱼJᵢⱼsᵢsⱼ+Σᵢhᵢsᵢ Equation (1)

Both i and j in Equation (1) are variables representing spins. Also, sᵢ is a variable representing the orientation of spin i, and sⱼ is a variable representing the orientation of spin j in Equation (1). In other words, sᵢ and sⱼ are variables that are either “1” or “−1”.

Also, hᵢ in Equation (1) is a constant corresponding to spin i. For each possible value of i, hᵢ is determined as a constant. Jᵢⱼ in Equation (1) is a constant corresponding to the combination of spin i and spin j. For each possible combination of values of i and j, Jᵢⱼ is determined as a constant.

The Ising model in the case of total coupling can be represented, for example, by a complete graph. FIG. 10 is an explanatory diagram showing an example of a complete graph when the number of spins is seven.

The white arrows shown in FIG. 10 represent spins. Upward pointing white arrows represent spins where the value of the variable is “1”. The downward pointing white arrows represent spins where the value of the variable is “−1”.

Each edge connecting the white arrows represents a combination between spins. Each edge is assigned the value of Jᵢⱼ corresponding to the combination of spins, respectively.

Instead of the energy function in the Ising model, a QUBO (Quadratic Unconstrained Binary Optimization) energy function may be used. QUBO is a model that represents the orientation of each spin by “1” or “0”.

That is, the equation representing the energy in a combinatorial optimization problem can be converted to an energy function in QUBO. This conversion method is well known. Hereafter, a combinatorial optimization problem is said to be described in QUBO form when the equation representing the energy in the combinatorial optimization problem is represented by an energy function in QUBO.

The energy function in the Ising model and the energy function in QUBO are mutually convertible. The energy function in QUBO is represented as in the following Equation (2).

[Math. 2]

H_{QUBO}=ΣᵢⱼQᵢⱼxᵢxⱼ (x=(s+1)/2) Equation (2)

Both i and j in Equation (2) are variables representing spins. Also, xᵢ in Equation (2) is a variable representing the orientation of spin i, and xⱼ is a variable representing the orientation of spin j. Also, Qᵢⱼ in Equation (2) is a constant corresponding to the combination of spin i and spin j. For each possible combination of values of i and j, Qᵢⱼ is determined as a constant.

Given the energy function shown in Equation (1), the optimal individual spin orientation (1 or −1) is found when the combinatorial optimization problem is solved. Given the energy function shown in Equation (2), the optimal individual spin orientation (1 or 0) is found when the combinatorial optimization problem is solved. The optimal individual spin orientations found represent the solution to the combinatorial optimization problem.

For example, many combinatorial optimization problems can be attributed to minimization problems which are the problems of finding a combination that minimizes an arbitrary objective function (minimization target) under given constraints. When the combinatorial optimization problem is a minimization problem, the optimal individual spin orientation is the orientation of the individual spins such that the energy indicated by the energy function is as small as possible.

As mentioned above, the development of quantum computers capable of solving combinatorial optimization problems described in Ising model form at high speed has led to a growing interest in a study applying combinatorial optimization techniques. Quantum computers that use quantum mechanics are sometimes referred to as “real quantum”.

Non Patent Literature (NPL) 1 describes a dedicated hardware solver for solving combinatorial optimization problems that provides both cloud and on-premise services.

NPL 2 describes a real quantum hardware that provides cloud services and executes quantum annealing.

In addition, Patent Literature (PTL) 1 describes an optimization device that can set optimal input parameters simply and quickly, even when the number of dimensions of input parameters is large.

In addition, PTL 2 describes an optimal solution search method that can reduce the search processing time and the amount of memory required for the search process by using solution information that has already been detected.

### CITATION LIST

### Patent Literature

PTL 1: Japanese Patent Application Laid-Open No. 2020-027370
PTL 2: Japanese Patent Application Laid-Open No. Hei 7-319848

### Non Patent Literature

NPL 1: “Physics-Inspired Optimization for Quadratic Unconstrained Problems Using a Digital Annealer,” [online], Frontiers, [retrieved Jul. 6, 2020]
NPL 2: D-Wave, “PRACTICAL QUANTUM COMPUTING D-Wave Technology Overview,” D-Wave Systems Inc, 2020.

### SUMMARY OF INVENTION

### Technical Problem

When a combinatorial optimization problem is input, the solver described in NPL 1 solves the input combinatorial optimization problem by a simulated annealing method and returns a solution to the combinatorial optimization problem. The user of the solver described in NPL 1 determines the control parameters, which are parameters for controlling the solver, before inputting the combinatorial optimization problem to the solver, and adjusts the control parameters based on the returned solution.

The type of accuracy required for optimization calculations depends on the user. For example, there are users who want a solution in a short time, even if it requires less accuracy, and there are users who want a solution with higher accuracy, even if it requires longer computation time.

When using a solver that returns a solution after solving as described above, the user adjusts control parameters using the returned solution based on the type of accuracy required by he or she. In other words, it is difficult for the user to determine the control parameters such as a computation time for the combinatorial optimization problem while the solving process is still being executed, in order to maximize the accuracy required by each user, because the solution has not yet been returned.

NPLs 1-2 and PTLs 1-2 do not describe a method to improve the accuracy of the solution of a combinatorial optimization problem while the solving process is being executed by a simulated annealing method.

Therefore, it is an object of the present invention to provide a state output system, a state output method, and a state output program that can output the states of the solving process during execution of the solving process by the simulated annealing method for combinatorial optimization problems.

### Solution to Problem

A state output system according to the present invention is a state output system includes a solving means which executes a solving process for solving a combinatorial optimization problem by a simulated annealing method, an acquiring means which acquires data indicating states of the solving process in execution from the solving means, and an outputting means which outputs the acquired data during the execution of the solving process.

A state output method according to the present invention is a state output method includes executing a solving process for solving a combinatorial optimization problem by a simulated annealing method, acquiring data indicating states of the solving process in execution, and outputting the acquired data during the execution of the solving process.

A computer-readable recording medium recording a state output program according to the present invention, when executed by a computer, stores the state output program causing the computer to execute executing a solving process for solving a combinatorial optimization problem by a simulated annealing method, acquiring data indicating states of the solving process in execution, and outputting the acquired data during the execution of the solving process.

### Advantageous Effects of Invention

According to this invention, it is possible to output the states of the solving process during execution of the solving process by the simulated annealing method for combinatorial optimization problems.

### BRIEF DESCRIPTION OF DRAWING

FIG. 1 is an explanatory diagram showing a concept of a solving method for a combinatorial optimization problem by a simulated annealing method.

FIG. 2 is an explanatory diagram showing an example of the display of the minimum value, temperature, and freezing degree for the combinatorial optimization problem obtained by the simulated annealing method.

FIG. 3 is a block diagram showing an example of the configuration of a state display system of the example embodiment of the present invention.

FIG. 4 is a flowchart showing an operation of the combinatorial optimization problem solving process by the state display system 1000 of this example embodiment.

FIG. 5 is an explanatory diagram showing an example of the display of the minimum value, temperature, and freezing degree for a delivery planning optimization problem by the state display system 1000.

FIG. 6 is an explanatory diagram showing an example of a hardware configuration of a user terminal 100 according to the present invention.

FIG. 7 is an explanatory diagram showing an example of a hardware configuration of a solver 200 according to the present invention.

FIG. 8 is a block diagram showing an overview of a state output system according to the present invention.

FIG. 9 is an explanatory diagram showing an example of a solution to the shift optimization problem.

FIG. 10 is an explanatory diagram showing an example of a complete graph when the number of spins is seven.

### DESCRIPTION OF EMBODIMENTS

First, we will explain, regarding the above-described problem, a content of the problem when a combinatorial optimization problem described in Ising model or QUBO form is solved by a simulated annealing method (hereinafter referred to as the SA method), specifically.

The SA method is a general-purpose method for solving combinatorial optimization problems in an approximate manner. The SA method solves combinatorial optimization problems with the following five processes as one cycle.
1. select one spin
2. flip the selected spin
3. calculate the change amount in the energy ΔH due to spin flipping
4. with probability min(exp(−ΔH/T),1), accept spin flipping
5. lower temperature T slightly and return to 1.

The plan that specifies the change in temperature T in the above process over the course of a cycle (gradually decreasing, etc.) is called a “temperature schedule”. The temperature schedule may be determined by the user in any way.

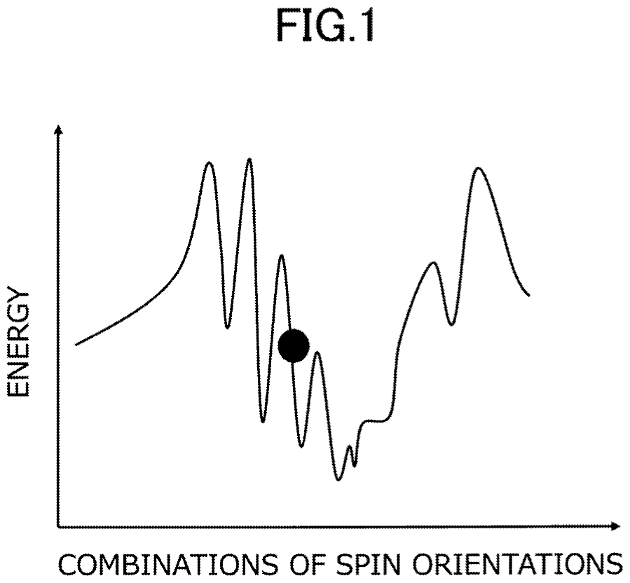

FIG. 1 is an explanatory diagram showing a concept of a solving method for a combinatorial optimization problem by the SA method. The example shown in FIG. 1 is an example of solving a minimization problem by the SA method.

The vertical and horizontal axes of the graphs shown in FIG. 1 represent energy and combinations of multiple spin orientations, respectively. The curve shown in FIG. 1 represent, for example, the energy function in the Ising model. The black circle shown in FIG. 1 is an example of the value of energy when the solution obtained by the SA method is used.

The process of finding a solution to the minimization problem corresponds to the process of searching for the valley bottom in the curve shown in FIG. 1. The SA method can search widely crossing the predetermined degree high peaks in the curve shown in FIG. 1 while the temperature is high. However, when the temperature is low, the SA method cannot cross the peaks and transitions to the deepest valley bottom with high probability.

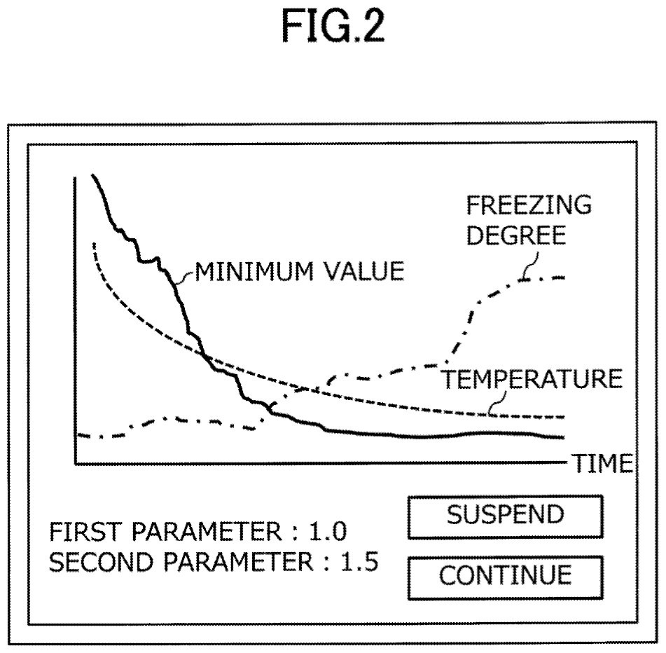

FIG. 2 is an explanatory diagram showing an example of the display of the minimum value, temperature, and freezing degree for the combinatorial optimization problem obtained by the SA method. The double frame shown in FIG. 2 represents an arbitrary screen.

The graphs in the screen shown in FIG. 2 display the minimum value, temperature, and freezing degree between the beginning and the end of the minimization problem solving process by the SA method. The horizontal axis of the graph shown in FIG. 2 represents time. In other words, the graph shown in FIG. 2 represents the states of the combinatorial optimization problem solving process by the SA method.

The “minimum value” in the graph shown in FIG. 2 is the value to be minimized when the solution obtained by the SA method is used. The “temperature” in the graph shown in FIG. 2 is the above temperature T in the solving process by the SA method.

The “freezing degree” in the graph shown in FIG. 2 is a value indicating the degree to which freezing occurs in SA, i.e., the degree to which spin flipping is rejected. The freezing degree is defined, for example, as follows.

(freezing degree)=(the number of combinations of multiple spin orientations updates rejected)/(the number of combinations of multiple spin orientations updates attempted)

Therefore, if the freezing degree remains high, as in the second half of the graph shown in FIG. 2, it is clear that the continuation of the solving process is futile. A too high freezing degree means that the temperature is too low to search.

The “first parameter” and “second parameter” shown in FIG. 2 are the control parameters described above. For example, a change in the value of the first parameter changes the temperature schedule.

The rectangle labeled “suspend” shown in FIG. 2 is a button in the graphical user interface (GUI) that can be operated by the user. When the “suspend” button is operated, the solver that solves the combinatorial optimization problem by the SA method receives an instruction to suspend the solving process.

The rectangle labeled “continue” shown in FIG. 2 is a button in the GUI that can be operated by the user. When the “continue” button is operated, the solver that solves the combinatorial optimization problem by the SA method receives an instruction to continue executing the solving process.

The solver, which solves the combinatorial optimization problem by the SA method, is inputted the combinatorial optimization problem to be solved. In addition, search time, temperature schedule, initial solution, etc. are input to the solver as control parameters. The solver solves the combinatorial optimization problem based on the input control parameters.

For combinatorial optimization problems for which the graphs are not yet displayed, it is difficult for the user to determine the temperature schedule, etc. so as to maximize the required accuracy for each user, because the graphs are not displayed.

In order to maximize the accuracy required for a combinatorial optimization problem while the solving process is being executed, the minimum value and freezing degree should be displayed during execution of the solving process. The display of the minimum value and freezing degree prompts the user to decide whether to suspend or continue the solving process.

By displaying the minimum value and the freezing degree during execution of the solving process, the user can, for example, suspend the futile search earlier. If, for example, there is room for further search, the user can continue executing the solving process. In other words, the efficiency of the search for solutions to combinatorial optimization problems is expected to increase. In addition, the user can adjust control parameters based on the visualized contents of the states of the solving process.

[Description of Configuration]

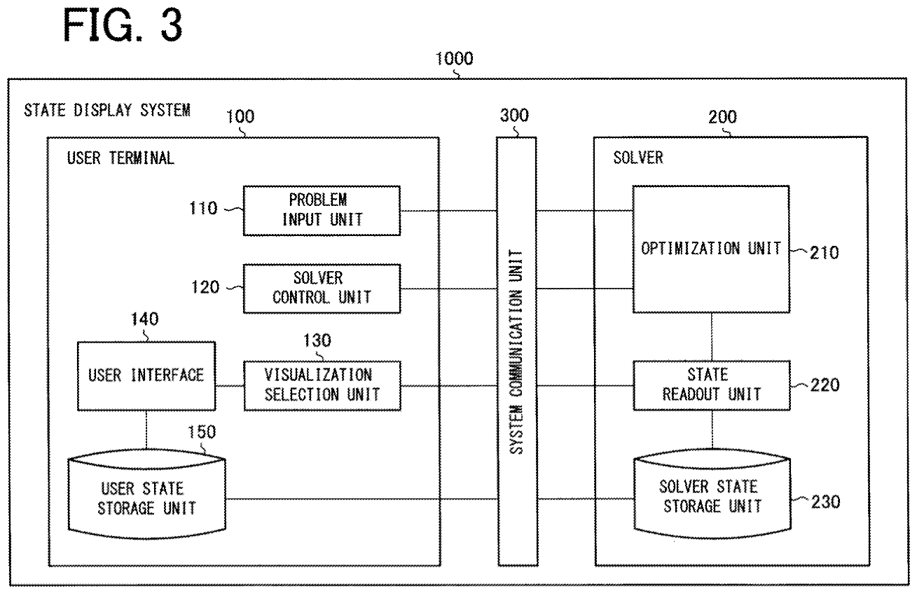

Hereinafter, an example embodiment of the present invention is described with reference to the drawings. FIG. 3 is a block diagram showing an example of the configuration of a state display system of the example embodiment of the present invention.

As shown in FIG. 3, the state display system 1000 includes a user terminal 100, a solver 200, and a system communication unit 300. The user terminal 100 is communicatively connected to the solver 200 via the system communication unit 300.

As shown in FIG. 3, the user terminal 100 includes a problem input unit 110, a solver control unit 120, a visualization selection unit 130, a user interface 140, and a user state storage unit 150.

The problem input unit 110 has the function of inputting a combinatorial optimization problem to be solved to the solver 200. The problem input unit 110 inputs, for example, a combinatorial optimization problem described in Ising model form or a combinatorial optimization problem described in QUBO form.

The solver control unit 120 has the function of inputting control parameters such as search time, temperature schedule, and initial solution to the solver 200.

The visualization selection unit 130 has the function of selecting the states to be visualized among the states of the solving process by the solver 200, i.e., the states displayed in a graph. In the example of the graph shown in FIG. 2, the visualization selection unit 130 selects “minimum value,” “temperature,” and “freezing degree” as states to be displayed in the graph.

The states of the solving process in this example embodiment include the minimum value, temperature, and freezing degree. The states of the solving process may include other states. The visualization selection unit 130 inputs information indicating the selected states to the solver 200.

The user interface 140 has input/output functions. For example, the user interface 140 displays the screen shown in FIG. 2 to output the values returned from the solver 200. The component that outputs the value returned from the solver 200 may not be included in the user terminal 100.

The instructions from the user are input to the user interface 140. For example, a state to be displayed in the graph is input to the user interface 140 from the user. When the state to be displayed in the graph is input, the user interface 140 inputs information indicating the input state to the visualization selection unit 130.

For example, when the “suspend” button shown in FIG. 2 is operated, the user interface 140 receives an instruction to suspend the solving process. Upon receiving the instruction, the user interface 140 sends information indicating that the user has requested the suspend of the solving process to the solver 200.

Similarly, when the “continue” button shown in FIG. 2 is operated, the user interface 140 receives an instruction to continue executing the solving process. Upon receiving the instruction, the user interface 140 sends information indicating that the user has requested that the continuation of the solving process to the solver 200.

The user state storage unit 150 has the function of storing data indicating the states of the solving process by the solver 200. Specifically, the user state storage unit 150 stores time series data of the states displayed in the graph shown in FIG. 2. The user interface 140 uses the time series data stored in the user state storage unit 150 to display the graph shown in FIG. 2.

As shown in FIG. 3, the solver 200 includes an optimization unit 210, a state readout unit 220, and a solver state storage unit 230.

The optimization unit 210 has the function of solving the combinatorial optimization problem to be solved input from the user terminal 100 based on the control parameters input from the user terminal 100.

The optimization unit 210 solves combinatorial optimization problems by the SA method. The optimization unit 210 is realized, for example, by an SA machine.

The state readout unit 220 has the function of reading out from the optimization unit 210 the time series data in the state selected by the visualization selection unit 130 among the states of the solving process of the combinatorial optimization problem by the optimization unit 210. The state readout unit 220 stores the read out time series data in the solver state storage unit 230.

The system communication unit 300 transfers the time series data of the states stored in the solver state storage unit 230 to the user state storage unit 150.

The optimization unit 210 inputs the solution to the combinatorial optimization problem solved by the SA method to the user terminal 100. The user terminal 100 includes a storage unit (not shown) different from the user state storage unit 150, where the solution to the input combinatorial optimization problem is stored.

[Description of Operation]

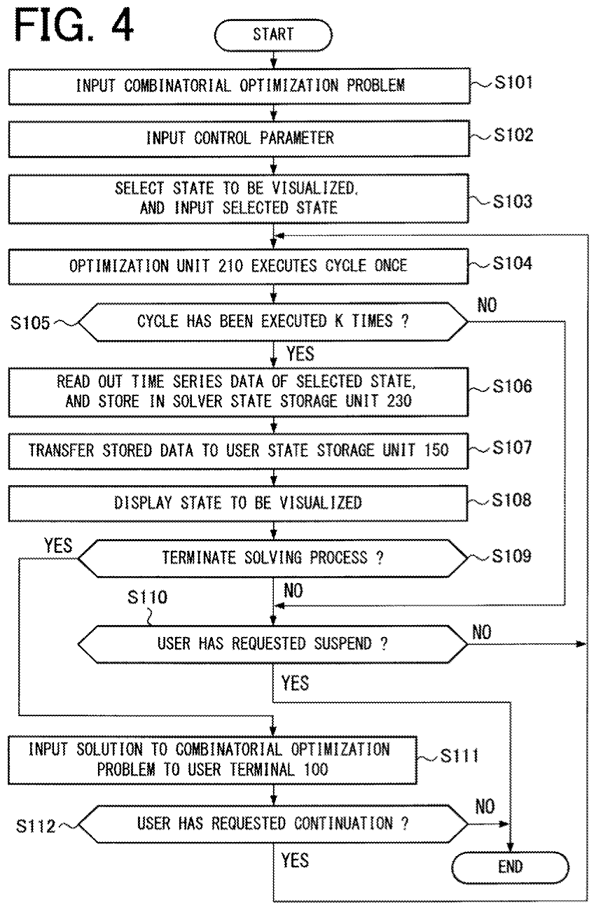

Hereinafter, the operation of the state display system 1000 of this example embodiment will be described with reference to FIG. 4. FIG. 4 is a flowchart showing an operation of the combinatorial optimization problem solving process by the state display system 1000 of this example embodiment.

First, the problem input unit 110 of the user terminal 100 inputs a combinatorial optimization problem to be solved to the solver 200 (step S101). Next, the solver control unit 120 inputs control parameters to the solver 200 (step S102).

Next, the visualization selection unit 130 selects a state to be visualized among the states of the solving process and inputs information indicating the selected state to the solver 200 (step S103).

Next, the optimization unit 210 of the solver 200 solves the input combinatorial optimization problem to be solved based on the input control parameters. Specifically, the optimization unit 210 executes the above cycle once (step S104).

Note that executing the above cycle once is equivalent to one attempt to update the combinations of multiple spin orientations represented by the Ising model used to describe the combinatorial optimization problem to be solved.

Next, the state readout unit 220 checks whether the cycle has been executed K times (K is a positive integer) (step S105). K is a value that depends on the size of the combinatorial optimization problem to be solved. If the cycle has not been executed K times (No in step S105), the state readout unit 220 proceeds to the processing of step S110.

When the cycle has been executed K times (Yes in step S105), the state readout unit 220 reads out the time series data of the input state to be visualized among the states of the solving process by the optimization unit 210. The time series data of the states read out by the state readout unit 220 is the data corresponding to the K cycles executed.

The state readout unit 220 stores the read-out time series data in the solver state storage unit 230 (step S106). Next, the system communication unit 300 transfers the time series data stored in the solver state storage unit 230 to the user state storage unit 150 (step S107).

Next, the user interface 140 uses the time series data stored in the user state storage unit 150 to display the state to be visualized (step S108).

Next, the optimization unit 210 determines whether to terminate the solving process for the combinatorial optimization problem to be solved (step S109). For example, when a predetermined number of cycles have been executed or a solution with a predetermined accuracy or higher has been obtained, the optimization unit 210 terminates the solving process.

If the determination is made not to terminate the solving process (No in step S109), the optimization unit 210 checks whether the user has requested the suspend of the solving process (step S110). If the user has not requested the suspend of the solving process (No in step S110), the optimization unit 210 returns to the processing of step S104.

If the user has requested the suspend of the solving process (Yes in step S110), the state display system 1000 terminates the combinatorial optimization problem solving process. The state display system 1000 may suspend the combinatorial optimization problem solving process without terminating it.

If the determination is made to terminate the solving process (Yes in step S109), the optimization unit 210 inputs the solution to the combinatorial optimization problem to the user terminal 100 (step S111).

Next, the optimization unit 210 checks whether the user has requested the continuation of the solving process (step S112). If the continuation of the solving process is requested (Yes in step S112), the optimization unit 210 returns to the processing of step S104. If the continuation of the solving process is not requested (No in step S112), the state display system 1000 terminates the combinatorial optimization problem solving process.

As described above, the state display system 1000 of this example embodiment includes the optimization unit 210 that executes a solving process for solving a combinatorial optimization problem by the SA method, and a state readout unit 220 that acquires data indicating the states of the solving process in execution from the optimization unit 210.

The state display system 1000 includes a user interface 140 that outputs the acquired data during the execution of the solving process. The user interface 140 displays the acquired data in a graph form, for example.

The data indicating the states of the solving process is, for example, the value to be optimized in the combinatorial optimization problem (e.g., the minimum value) when the solution to the combinatorial optimization problem which the optimization unit 210 has calculated by solving by the SA method is used.

The data indicating the states of the solving process is, for example, the freezing degree, which is the ratio of the number of combinations of multiple spin orientations updates rejected to the number of combinations of multiple spin orientations updates attempted represented by the Ising model used to describe the combinatorial optimization problem, or the temperature in the solving process.

The state readout unit 220 may acquire the data every predetermined number (e.g., K) of attempts to update the combinations of multiple spin orientations represented by the Ising model used to describe the combinatorial optimization problem. The user interface 140 may output data every predetermined number of attempts to update the combinations of multiple spin orientations.

The instructions for the solving process from the user are input to the user interface 140. When an instruction to suspend the solving process is input to the user interface 140, the optimization unit 210 suspends the solving process. When an instruction to continue executing the solving process is input to the user interface 140, the optimization unit 210 continues to execute the solving process.

### Description of Effect

In the state display system 1000 of this example embodiment, the user interface 140 displays the states of the solving process by the optimization unit 210, such as the minimum value, temperature, or freezing degree, each K times the cycle is executed.

In other words, based on the displayed contents, the user can request that the solving process be suspended or continued, according to the type of accuracy of the solution he is solving. When the states are displayed, the user can detect cases in the early stages of the solving process, especially when the control parameters are far from their optimal values. When the states are visualized as in the graph shown in FIG. 2, the user can easily determine the direction of control parameter tuning.

The state display system 1000 of this example embodiment can reduce the learning cost of CUI (Character User Interface). For example, when using a solver with a CUI-based interface, the user may be required to input the problem to be solved into the solver while referring to an API (Application Programming Interface) reference and interpret the returned values.

In other words, the user who is required to handle the CUI-based interface have difficulty using the solver unless they fully understand the manuals, etc. The burden on the user side, such as having to understand manuals, etc., corresponds to the learning cost of CUI described above.

The state display system 1000 of this example embodiment can display the states of the solving process by the optimization unit 210 in a graph form. In other words, the user can easily grasp the direction of control parameter tuning simply by referring to the displayed graph, thus reducing the learning cost of CUI.

A specific example of how the state display system 1000 of this example embodiment solves the delivery plan optimization problem will be described in the following. When inputting the delivery plan optimization problem into the user interface 140, the user also inputs the delivery location together.

As described above, the user of the state display system 1000 can monitor the states of the solving process by the optimization unit 210 and determines whether to suspend the solving process of the delivery plan optimization problem and have it recalculated or whether to continue executing the solving process.

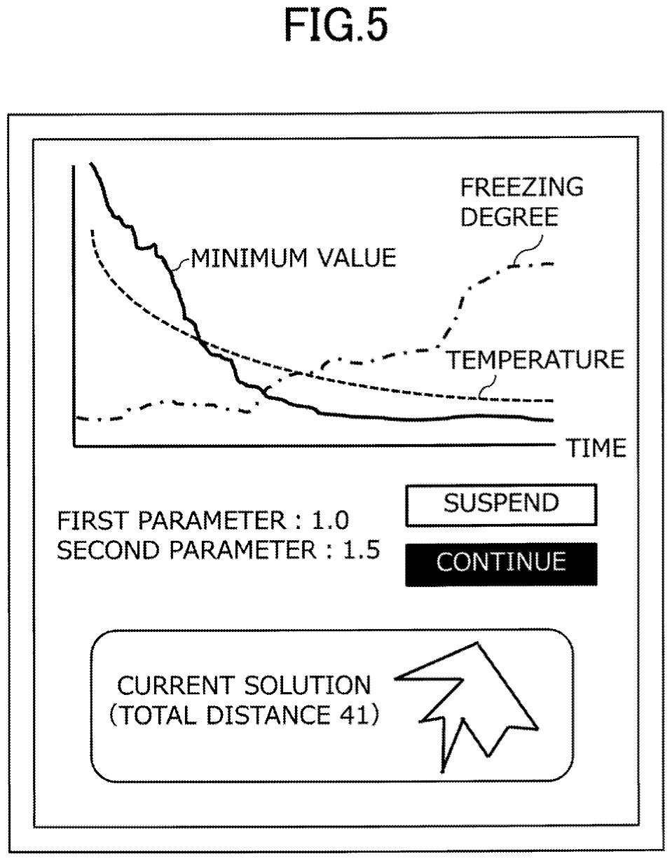

FIG. 5 is an explanatory diagram showing an example of the display of the minimum value, temperature, and freezing degree for a delivery planning optimization problem by the state display system 1000. In the example shown in FIG. 5, the specific shape of the solution, “current solution,” is displayed at the bottom.

The “current solution” shown in FIG. 5 represents the shape of the path that travels around the delivery locations in the delivery planning optimization problem. Specifically, each vertex and each edge of the “current solution” shown in FIG. 5 represent a delivery location and a route, respectively. When delivery is made along the route of the “current solution” shown in FIG. 5, the cost (total distance) is at or near the minimum value (“41” shown in FIG. 5). Note that the specific shape of the solution varies depending on the type of a combinatorial optimization problem.

In the example shown in FIG. 5, the “continue” button is colored black. The “continue” button with black color suggests to the user that there is a high possibility that a better solution can be obtained by continuing executing the solving process after the termination of the solving process by the optimization unit 210. If there is a low probability that a better solution will be obtained even if the executing the solving process by the optimization unit 210 is continued, the “suspend” button is colored black.

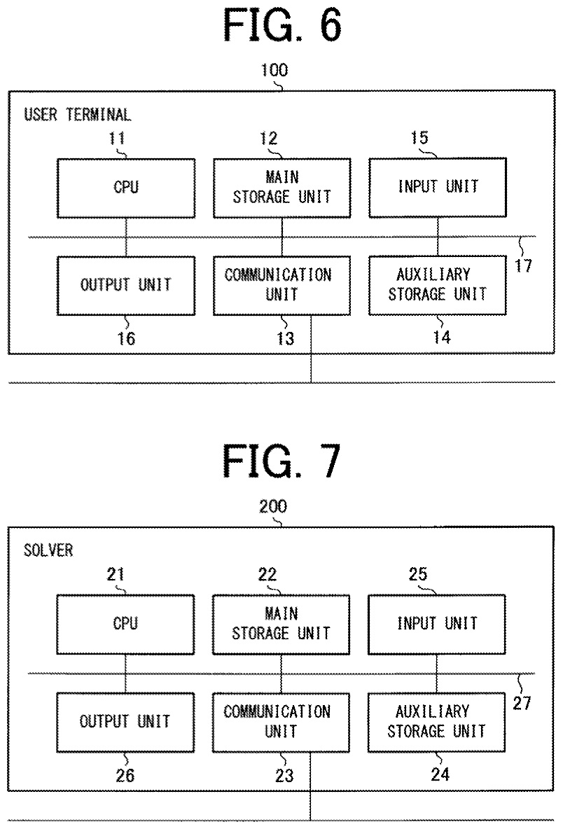

A specific example of a hardware configuration of the user terminal 100 according to this example embodiment will be described below. FIG. 6 is an explanatory diagram showing an example of a hardware configuration of the user terminal 100 according to the present invention.

The user terminal 100 shown in FIG. 6 includes a CPU (Central Processing Unit) 11, a main storage unit 12, a communication unit 13, and an auxiliary storage unit 14. The user terminal 100 also includes an input unit 15 for the user to operate and an output unit 16 for presenting a processing result or a progress of the processing contents to the user.

The user terminal 100 is realized by software, with the CPU 11 shown in FIG. 6 executing a program that provides a function that each component has.

Specifically, each function is realized by software as the CPU 11 loads the program stored in the auxiliary storage unit 14 into the main storage unit 12 and executes it to control the operation of the user terminal 100.

The user terminal 100 shown in FIG. 6 may include a DSP (Digital Signal Processor) instead of the CPU 11. Alternatively, the user terminal 100 shown in FIG. 6 may include both the CPU 11 and the DSP.

The main storage unit 12 is used as a work area for data and a temporary save area for data. The main storage unit 12 is, for example, RAM (Random Access Memory). The user state storage unit 150 of this example embodiment is realized by the main storage unit 12.

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The output unit 16 has a function to output data. The user interface 140 of this example embodiment is realized by the input unit 15 and the output unit 16.

As shown in FIG. 6, in the user terminal 100, each component is connected to the system bus 17.

The auxiliary storage unit 14 stores programs for realizing the problem input unit 110, the solver control unit 120, and the visualization selection unit 130 in the user terminal 100 of this example embodiment.

A specific example of a hardware configuration of the solver 200 according to this example embodiment will be described below. FIG. 7 is an explanatory diagram showing an example of a hardware configuration of the solver 200 according to the present invention.

The solver 200 shown in FIG. 7 includes a CPU 21, a main storage unit 22, a communication unit 23, and an auxiliary storage unit 24. The solver 200 also includes an input unit 25 for the user to operate and an output unit 26 for presenting a processing result or a progress of the processing contents to the user.

The solver 200 is realized by software, with the CPU 21 shown in FIG. 7 executing a program that provides a function that each component has.

Specifically, each function is realized by software as the CPU 21 loads the program stored in the auxiliary storage unit 24 into the main storage unit 22 and executes it to control the operation of the solver 200.

The solver 200 shown in FIG. 7 may include a DSP instead of the CPU 21. Alternatively, the solver 200 shown in FIG. 7 may include both the CPU 21 and the DSP.

The main storage unit 22 is used as a work area for data and a temporary save area for data. The main storage unit 22 is, for example, RAM. The solver state storage unit 230 of this example embodiment is realized by the main storage unit 22.

The communication unit 23 has a function of inputting and outputting data to and from peripheral devices through a wired network or a wireless network (information communication network).

The auxiliary storage unit 24 is a non-transitory tangible medium. Examples of non-transitory tangible media are, for example, a magnetic disk, an optical magnetic disk, a CD-ROM, a DVD-ROM, a semiconductor memory.

The input unit 25 has a function of inputting data and processing instructions. The input unit 25 is, for example, an input device such as a keyboard or a mouse.

The output unit 26 has a function to output data. The output unit 26 is, for example, a display device such as a liquid crystal display device, or a printing device such as a printer.

As shown in FIG. 7, in the solver 200, each component is connected to the system bus 27.

The auxiliary storage unit 24 stores programs for realizing the optimization unit 210 and the state readout unit 220 in the solver 200 of this example embodiment.

The user terminal 100 and the solver 200 may be implemented with a circuit that contains hardware components inside such as an LSI (Large Scale Integration) that realize the functions shown in FIG. 3, for example.

The user terminal 100 and the solver 200 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Instead of consisting of the two devices shown in FIG. 3, the state display system 1000 may be a single device. That is, the state display system 1000 may be a single device that includes all of the components of the user terminal 100, the solver 200, and the system communication unit 300.

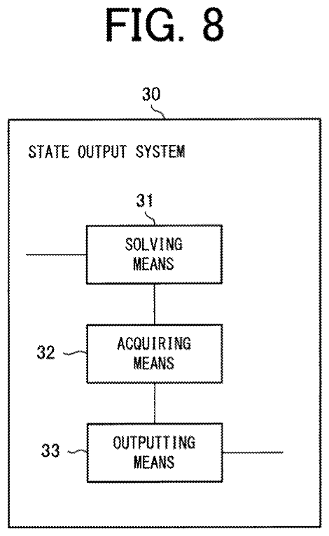

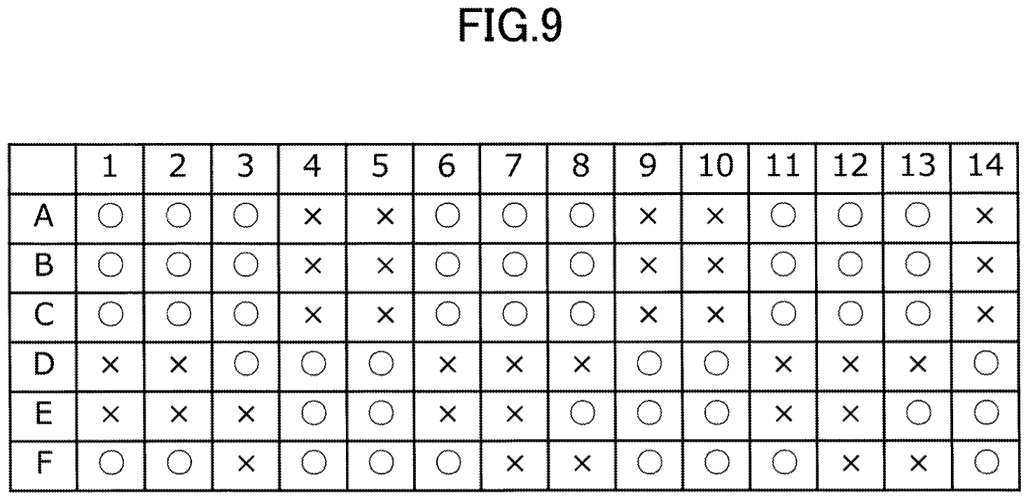

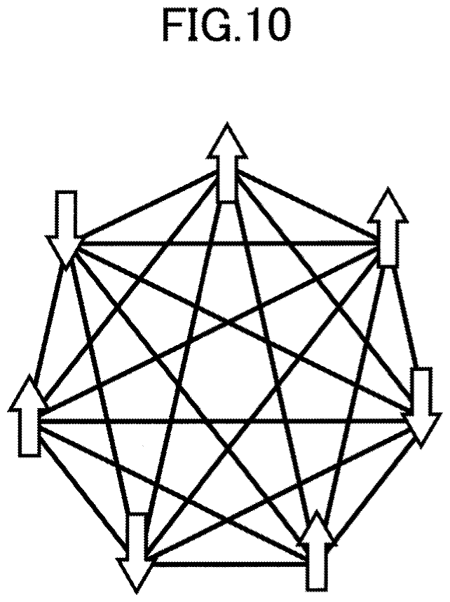

Next, an overview of the present invention will be explained. FIG. 8 is a block diagram showing an overview of a state output system according to the present invention. The state output system 30 according to the present invention includes a solving means 31 (for example, the optimization unit 210) which executes a solving process for solving a combinatorial optimization problem by a simulated annealing method, an acquiring means 32 (for example, the state readout unit 220) which acquires data indicating states of the solving process in execution from the solving means 31, and an outputting means 33 (for example, the user interface 140) which outputs the acquired data during the execution of the solving process.

With such a configuration, the state output system can output the states of the solving process during execution of the solving process by the simulated annealing method for combinatorial optimization problems.

The data indicating the states of the solving process may also be a value (for example, the minimum value) to be optimized in the combinatorial optimization problem when a solution to the combinatorial optimization problem which the solving means 31 has calculated by solving is used.

The data indicating the states of the solving process may also be a ratio (for example, the freezing degree) of a number of combinations of multiple spin orientations updates rejected to a number of the combinations of multiple spin orientations updates attempted represented by an Ising model used to describe the combinatorial optimization problem.

The data indicating the states of the solving process may also be temperature in the solving process.

With such a configuration, the state output system can present material that allows the user to decide whether to suspend or continue the solving process for the combinatorial optimization problem.

The acquiring means 32 may also acquire the data every predetermined number of attempts to update the combinations of multiple spin orientations represented by the Ising model used to describe the combinatorial optimization problem, and the output means 33 may also output data every the predetermined number of attempts to update the combinations of multiple spin orientations.

With such a configuration, the state output system can output the states during the execution of the solving process according to the size of the combinatorial optimization problem.

The state output system 30 may also include an input means (for example, the user interface 140) to which instructions for the solving process are input, and the solving means 31 may also suspend the solving process when an instruction to suspend the solving process is input to the input means.

With such a configuration, the state output system can allow the user to suspend the solving process for the combinatorial optimization problem even during the execution.

The solving means 31 may also continue to execute the solving process when an instruction to continue executing the solving process is input to the input means.

With such a configuration, the state output system can allow the user to resume the solving process for the combinatorial optimization problem.

The output means 33 may also display the acquired data in a graph form.

With such a configuration, the state output system can output the states of the solving process for the combinatorial optimization problem in execution in a form that is easier for the user to understand.

The state output system 30 shown in FIG. 8 may be realized with multiple devices or with a single device.

While the present invention has been explained with reference to the example embodiments and examples, the present invention is not limited to the aforementioned example embodiments and examples. Various changes understandable to those skilled in the art within the scope of the present invention can be made to the structures and details of the present invention.

### REFERENCE SIGNS LIST

11, 21 CPU
12, 22 Main storage unit
13, 23 Communication unit
14, 24 Auxiliary storage unit
15, 25 Input unit
16, 26 Output unit
17, 27 System bus
30 State output system
31 Solving means
32 Acquiring means
33 Outputting means
100 User terminal
110 Problem input unit
120 Solver control unit
130 Visualization selection unit
140 User interface
150 User state storage unit
200 Solver
210 Optimization unit
220 State readout unit
230 Solver state storage unit
300 System communication unit
1000 State display system

What is claimed is:

1. A state output system comprising:
a memory configured to store instructions; and
a processor configured to execute the instructions to:
execute a solving process for solving a combinatorial optimization problem by a simulated annealing method;
acquire data indicating states of the solving process in execution; and
output the acquired data during the execution of the solving process.

2. The state output system according to claim 1, wherein
the data indicating the states of the solving process is a value to be optimized in the combinatorial optimization problem when a solution to the combinatorial optimization problem calculated by solving is used.

3. The state output system according to claim 1, wherein
the data indicating the states of the solving process is a ratio of a number of combinations of multiple spin orientations updates rejected to a number of the combinations of multiple spin orientations updates attempted represented by an Ising model used to describe the combinatorial optimization problem.

4. The state output system according to claim 2, wherein
the data indicating the states of the solving process is temperature in the solving process.

5. The state output system according to claim 1, wherein the processor is further configured to execute the instructions to:
acquire the data every predetermined number of attempts to update the combinations of multiple spin orientations represented by the Ising model used to describe the combinatorial optimization problem; and
output data every the predetermined number of attempts to update the combinations of multiple spin orientations.

6. The state output system according to claim 1, wherein the processor is further configured to execute the instructions to:
suspend the solving process when an instruction to suspend the solving process is input.

7. The state output system according to claim 6, wherein the processor is further configured to execute the instructions to:
continue to execute the solving process when an instruction to continue executing the solving process is input.

8. The state output system according to claim 1, wherein the processor is further configured to execute the instructions to:
display the acquired data in a graph form.

9. A state output method comprising:
executing a solving process for solving a combinatorial optimization problem by a simulated annealing method;
acquiring data indicating states of the solving process in execution; and
outputting the acquired data during the execution of the solving process.

10. A computer-readable recording medium recording a state output program causing a computer to execute:
executing a solving process for solving a combinatorial optimization problem by a simulated annealing method;
acquiring data indicating states of the solving process in execution; and
outputting the acquired data during the execution of the solving process.
